(19) United States
(12) Patent Application Publication
(10) Pub. No.: US 2003/0114555 A1
(43) Pub. Date: Jun. 19, 2003

(54) Mill blending apparatus

(75) Inventor: Jonathan Martin Dixon Steele, Thrapston (GB)

Correspondence Address: Keith R. Derrington, Schirrmeister Ajamie, 711 Louisiana, Suite 2150, Houston, TX, 77002, US

(73) Assignee: ICO, Inc.

(21) Appl. No.: 10/020,720

(22) Filed: Dec. 13, 2001

(51) Int. Cl. C08K 3/00

(52) U.S. Cl. 523/333

(57) ABSTRACT

A method of coloring thermoplastic olefin resins and pulverizing resin pellets in a single step involving the steps of metering liquid coloring onto resin pellets and then passing the combination of liquid color and resin pellets into a mill blender. The liquid color is metered onto the plastic pellets at a rate of from less than 0.2% to less than 1.0% by weight of the plastic pellets. The mill blender receives the combination of plastic pellets and liquid color and pulverizes the mixture to produce a colored thermoplastic resin powder that is suitable for subsequent processing, such as roto-molding or slush-molding.

### BACKGROUND OF THE INVENTION

1. Field of the Invention

The invention relates generally to the field of polymeric resin powder coloring. More specifically, the present invention relates to an apparatus and system for coloring powdered resins, including polymer resin powders of all types.

2. Description of Related Art

Pulverized resins, particularly resins intended for use in thermoplastic molding and shaping operations, are typically sold as fine powders, with particle sizes generally being between 200 to 350 microns. These polymer powders are generally colored by the addition of dry pigment after it has been pulverized.

One traditional method of coloring polymer resins include admixing the polymer powder with a finely ground pigment which electrostatically clings to the outer surface of the polymer powder particles. Other methods of coloring exist that involve the use of high speed machinery to agitate a combination of polymer and pigment to produce a colored polymer. One example involves an apparatus with agitating blades and legs mounted on a frame that are lowered into a vessel for mixing the coloring agent with the polymer.

Another process involves incorporating a coloring agent with the polymer powder in a mixing device, such as a twin-cone blender. The mixed composition is then further mixed in any of a number of apparatuses that generates or adds heat to the composition, where the heat is controlled to aid in the blending of the coloring agent to the pigment. The mixing apparatuses listed include a twin-roll mill, a Banbury mixer, ribbon blender, a tumble blender, a conventional screw extruder, or any other device that allows heat to be added to the composition, or produced by the mixing. Examples of patents that include these devices are Scheibelhoffer et al., U.S. Pat. No. 5,670,561, Hahn, U.S. Pat. No. 3,632,369, Lerman et al., U.S. Pat. No. 3,674,734, Lerman et al, U.S. Pat. No. 3,449,291, and Tanaka, U.S. Pat. No. 5,779,360.

However some disadvantages exist regarding the previously known pigmenting processes of polymer powders. Pigment applied electrostatically can be easily removed by contact with solvents or friction caused the handling of the pigmented powder. It has been found that admixing pigment with the polymer powders results in a reduced structural strength of objects formed from those polymers. Additionally, the known pigmenting processes are applicable to polymer powder and do not work with polymer pellets. Current methods of pigmenting polymer involve pulverizing the polymer pellets to produce a polymer powder, then pigmenting the polymer powder.

Therefore, there exists a need for a process to add pigment to polymer, where the resulting polymer does not easily shed its color and whose structural integrity is not compromised by coloring. It is further desired to have a process where polymer pellets can be mixed with pigment and a colored polymer powder is produced, without the added step of pulverizing the pellets prior to the addition of the pigment.

### BRIEF SUMMARY OF THE INVENTION

Disclosed herein is a method of pulverizing and coloring thermoplastic resin pellets coloring in a single step, particularly olefin based polymer resins. According to this invention, the process for coloring thermoplastic resins comprises adding a suitable amount of liquid coloring compound to the thermoplastic olefin based resin. The rate of added liquid should be sufficient to thoroughly color the thermoplastic olefin based resin. After the liquid color is added to the resin, the mixture of liquid color and thermoplastic olefin based resin is passed into a mill blender where the mixture is pulverized for a time sufficient to fuse the liquid coloring compound onto each particle of the thermoplastic olefin based resin.

The process also includes maintaining the temperature of the mixture inside of the mill at between 85° C. and 125° C. during the milling process. The amount of coloring compound added to the thermoplastic olefin based resin can range less than 0.2% to in excess of 1.0% by weight, and preferably less than 0.2% by weight. It is important that the flow of liquid coloring compound onto the thermoplastic olefin based resin be at a constant rate. The particle size of the final product should be less than 600 microns.

### BRIEF DESCRIPTION OF THE SEVERAL VIEWS OF THE DRAWING

FIG. 1 provides a schematic view of Process for Coloring and Pulverizing Thermoplastic Resin Pellets.

FIG. 2 illustrates a combination of resin pellets and liquid color being pulverized with a rotor and stator to produce a colored polymer powder.

FIG. 3 depicts an overview of the rotor and stator of a mill blender.

FIG. 4 is an enlarged view of the teeth formed on the outer circumference of the rotor and the inner circumference of the stator.

### DETAILED DESCRIPTION OF THE INVENTION

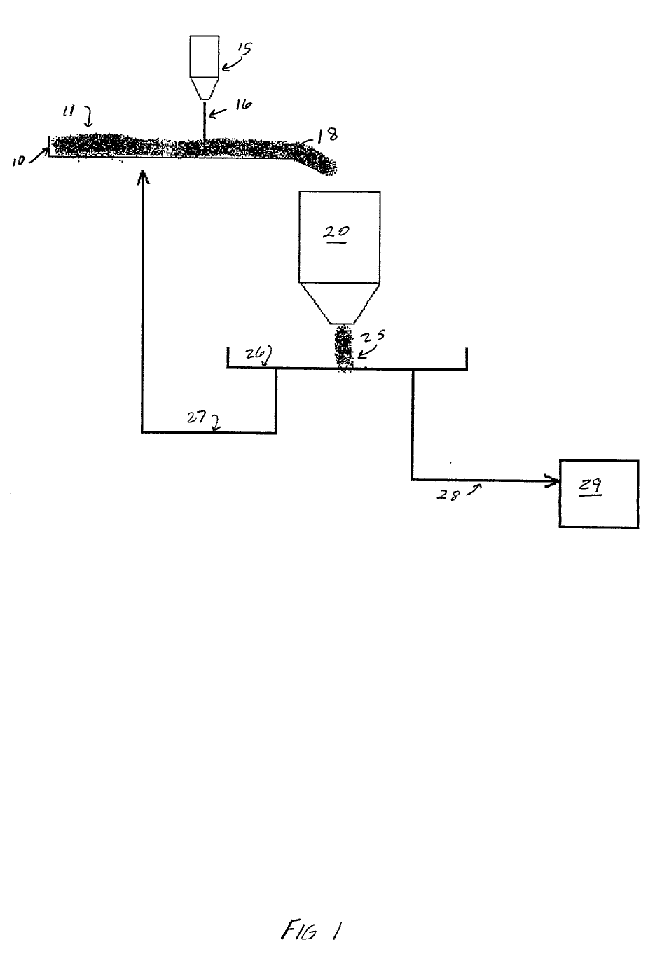

One embodiment of the present invention is disclosed in schematic form in FIG. 1. FIG. 1 illustrates a polymer feeder 10, a metering pump 15, a mill blender 20, and a separating sieve 26. The process involves combining liquid color 16 with plastic resin pellets 11 and processing the combination in the mill blender 20. This thoroughly coats the plastic resin pellets 11 with the liquid color 16 to produce a colored polymer powder 25 with excellent color properties. The colored polymer powder 25 produced by the present invention has superior color pigment stability which leads to plastic products where the coloring or pigment is not easily removed from the plastic but instead is vibrant and long lasting.

The plastic resin pellets 11 can be chosen from a wide variety of plastics, including thermoplastic olefin and polyolefin based resins such as polyethylene, polypropylene, and linear low density polyethylene. However, when used in conjunction with the present invention, the plastic resin pellets 11 should be in a pelletized form. The form of the plastic resin pellets 11 is important because the plastic resin pellets 11 must be in a semi-fluidized state to be handled by the polymer feeder 10.

It has been found that coloring plastics with a liquid instead of a dry powder form of pigment better distributes the coloring agent throughout the plastic that is being colored. One of the many advantages of liquid coloring is longer lasting color that is less likely to rub off or be otherwise removed from the plastic. As is known in the art, liquid color is produced by mixing a dry pigment with a carrier. The efficiency of liquid color is better than that of dry color pigmenting. This means that less actual pigment is required when a liquid color is used instead of a dry blend. Further, dry pigment can have the detrimental effect of acting as a foreign body in the finished polymer product. The presence of foreign bodies in the finished plastic can reduce tensile strength of the plastic. This problem of reduced tensile strength can be avoided by the implementation of liquid color. Additionally, liquid color produces more reliable coloring results than dry pigment. Thus the repeatability of achieving the desired color in the finished product is enhanced with using liquid color. A yet additional advantage to liquid color over dry pigment is that it is much easier to control the flow rate of liquid color into the polymer than dry pigment.

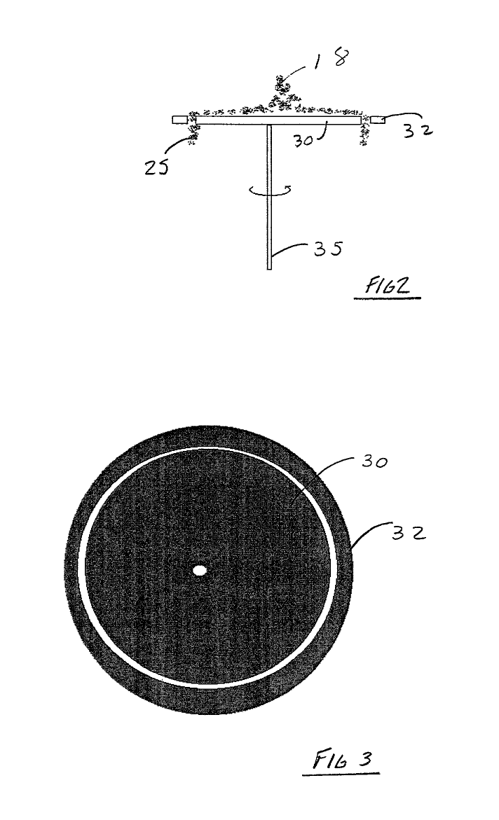

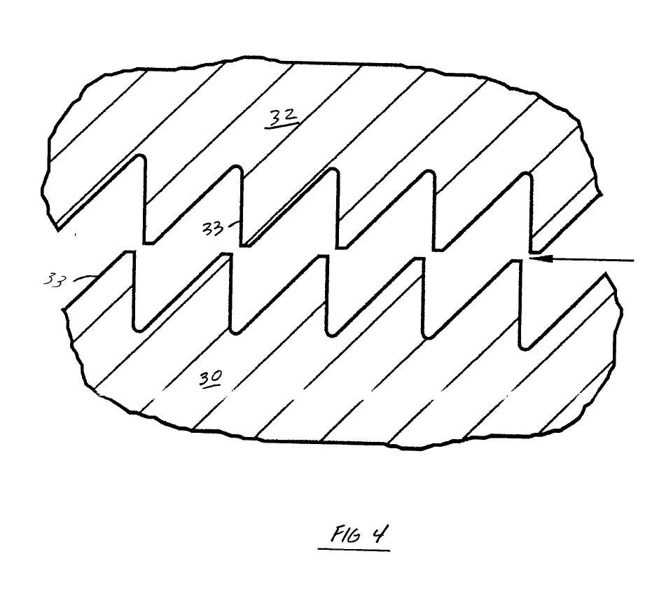

The mill 20, the preferred type of which is a WEDCO Model UR 28, is used as a one step method to pulverize the polymer pellets 11 into a polymer powder while at the same time bonding the liquid color 16 onto the polymer powder 25. A functional illustration of this process is illustrated in FIG. 2. The mill 20 differs from the traditional blend mixers in that it does not employ blades or paddles used in prior art devices. Instead, as shown in FIG. 3, the mill 20 includes a rotor 30 radially disposed within a stator 32. As seen in FIG. 4, formed on the outer radius of the rotor 30 are a series of teeth 33. Another set of teeth 33 are similarly formed on the inner radius of the stator 32. The gap between these two sets of teeth 33 is precisely machined to a predetermined distance which produces a desired polymer particle size as will be described in more detail below.

Before the coloring phase begins the process goes through a “start up” procedure involving activating the mill 20 and feeding plastic resin pellets 11 into the mill 20 via the polymer feeder 10. When the mill 20 is activated the rotor 30 begins to rotate as depicted in FIG. 2. Once fed into the mill 20 and inside of the mill 20, the plastic resin pellets 11 pass between the rotating rotor 30 and the stator 32. The pellets 11 are caught between the respective teeth 33 of the rotor 30 and the stator 32 and pulverized into powder form. The polymer powder particles produced by the mill 20 are very close in size to the gap between the teeth 33 of the rotor 30 and the stator 32. Accordingly, the gap between the rotor 30 and stator 32 teeth 33 is adjusted based on what size polymer powder particle size is desired. For the purposes of the invention disclosed herein that size is approximately 600 microns. Because the polymer particle size is important, during the life of the mill 20 the gap is closely monitored to ensure that the same size particle is produced by the mill 20.

The temperature of the polymer powder exiting the mill 20 during start up is checked until it reaches a steady state of about 85° C. to 125° C. At this time the liquid color or pigment 16 is dosed onto the plastic resin pellets 11 through a metering pump 15. The metering pump 15 can be any fluid handling device capable of producing a steady flow of liquid at a wide range of flow rates. More importantly, the metering pump 15 must be capable of supplying fluid at low flow rates on the order of 5 kg/hr or less. A standard peristaltic pump is the preferred type of pump for metering the liquid color 16 onto the plastic resin pellets 11.

The mill 20 operates in the same manner when the mixture of liquid color 16 and plastic resin pellets 11 passes through it as it does during start up. Except that with the addition of the liquid color 11, the pulverizing action of the mill 20 acts not only to pulverize the pellets 15 into powder, but also impinges the pigment inherent in the liquid color 16 onto the polymer particles. This impinging action fuses the color onto the polymer powder particles to produce a colored polymer powder 25. One of the many advantages of utilizing the mill 20 to color the plastic resin pellets 11 is that the pellets 11 can be colored and pulverized in a single step. Further, the polymer powder colored in this manner requires less pigment to be colored than processes using traditional mixing techniques. Also, because of the improved fusion of the pigment onto the polymer powder colored by the process disclosed herein, the subject powder will retain its color better than polymers colored by known mixing processes.

As is known in the art, the magnitude of the liquid color 16 flow rate will depend upon what color intensity or hue is desired in the final product. Coloring the polymer so that the final product has the desired color is what is known as a color match. The metering pump 15 is calibrated so the flow of liquid color 16 provided by the metering pump 15 mixed with the plastic resin pellets 11 produces the specified color match. Calibrating the metering pump 15 to produce the desired color match is well known to those skilled in the art. After the metering pump 15 is calibrated the colored product will reflect the desired hue as long as the flow rate of plastic resin pellets 11 into the mill 20 does not change. Varying the metering pump 15 flow with changes in voltage to the polymer feeder 10 allows for a continuous coloring process instead of the batch mixing processes that are currently used. Repeatability and consistency in producing a colored polymer powder are some of the advantages of a continuous process over a batch process.

To compensate for changes in the pellet flow rate, a control feedback system (not shown) is included that operatively couples the mass flow of the metering pump 15 to the mass flow of the polymer feeder 10. This will serve to assure that the proper mass flow of liquid color 16 is dosed onto the plastic resin pellets 11. The control feedback system proportionally varies the liquid color 16 feed rate with variations in the plastic resin pellets 11 flow rate. The proportional changes have a linear relationship. This results in colored polymers having a consistent and repeatable amount of coloring. Thus, once the system is calibrated and stabilized, it can operate without excessive supervision thereby ensuring consistent coloring results at a reduced manpower cost. It is appreciated that such a control system would be obvious to one skilled in the art.

As is well known in the art the polymer feeder 10 can be comprised of a vibratory feeder or a screw feeder. While both embodiments will adequately perform the required function, the screw feeder is preferred due to its more consistent and uniform mass flow characteristics. Further, one embodiment of the flow control system involves the use of corresponding load cells under the metering pump 15 and the polymer feeder 10 to produce a gravimetric flow relationship. The load cells under the metering pump 15 and the polymer feeder 10 can be calibrated to provide an accurate indication which results in a very precise control of the mass flow relationship of the liquid color and the polymer.

As the colored polymer powder 25 exits the mill blender 20 it is passed through a separating sieve 26. The separating sieve 26 is designed to pass only particles that are 600 micron and smaller. Particles larger than 600 microns disaffect the aesthetics of the final plastic product by giving it a speckled appearance. To eliminate this problem, these larger particles are separated from the final colored product and are channeled through the return line 27 back onto the mill blender 20 for additional processing. Colored polymer particles emanating from the mill blender 20 that are less than 600 microns in size are transferred through the processing line 28 to a final product bin 29.

The powder deposited into the final product bin 29 can then be further processed and formed into a final polymeric object. Numerous processes can be employed using the colored polymer powder 25 formed by the present invention, these include roto-molding and slush molding. Additionally, use of the present invention in conjunction with roto-molding produces final form plastics whose physical properties of tensile or impact strength can be equal to traditional manners of coloring polymeric compounds, which are generally more costly. An example of such a traditional coloring method includes extrusion compounding.

This description is made with reference to the preferred embodiment of the invention. However, it is possible to make other embodiments that employ the principles of the invention and that fall within its spirit and scope as defined by the following claims.

What is claimed is:

1. A process for coloring thermoplastic olefin based resins comprising the steps of:
adding a suitable amount of liquid coloring compound to the thermoplastic olefin based resin at a rate sufficient to color the thermoplastic olefin based resin;
passing the mixture of liquid coloring compound and thermoplastic olefin based resin into a mill; and
pulverizing the mixture of liquid coloring compound and thermoplastic olefin based resin inside of the mill for a time sufficient to fuse said liquid coloring compound onto each particle of the thermoplastic olefin based resin.

2. The process of claim 1 further comprising maintaining the temperature of the mixture inside of the mill at between 85° C. and 125° C. during the milling process.

3. The process of claim 1 where the amount of coloring compound added to the thermoplastic olefin based resin is less than 1.0% by weight.

4. The process of claim 1 where the amount of coloring compound added to the thermoplastic olefin based resin is less than 0.2% by weight.

5. The process of claim 1 where the flow of liquid coloring compound onto the thermoplastic olefin based resin is at a constant rate.

6. The process of claim 1 further comprising pulverizing the thermoplastic olefin based resin to an average size of less than 600 microns.

7. The process of claim 1 further comprising the step of varying the mass flow rate of liquid coloring compound flow rate based on changes in the mass flow rate of thermoplastic olefin based resin entering said mill.

8. The process of claim 1, wherein said mill includes a rotating rotor coplaneraly disposed within a stator having an annulus formed to radially circumscribe the outer circumference of said rotating rotor.

9. The process of claim 8 wherein said rotating rotor has a plurality of teeth on its outer radius.

10. The process of claim 8 wherein said stator has formed on its inner radius a plurality of teeth in cooperation with said plurality of teeth on said rotating rotor to form a gap between said teeth such that when a mixture of polymer pellets and liquid coloring compound passes through said gap the polymer pellets will be pulverized by the opposing action of said teeth into polymer powder particles and said liquid coloring compound is embedded onto the surface of the polymer powder particles thereby in a single step pulverizing said polymer pellets and producing polymer powder particles colored by said liquid coloring compound.
